(19) United States
(12) Patent Application Publication
(10) Pub. No.: US 2009/0215414 A1
(43) Pub. Date: Aug. 27, 2009

(54) AM BROADCAST RECEIVING CIRCUIT

(75) Inventors: Takeshi Ikeda, Tokyo (JP); Hiroshi Miyagi, Yokohama-shi (JP)

Correspondence Address: CONNOLLY BOVE LODGE & HUTZ LLP, 1875 EYE STREET, N.W., SUITE 1100, WASHINGTON, DC, 20006, US

(73) Assignee: NSC CO., LTD., Tokyo (JP)

(21) Appl. No.: 12/393,134

(22) Filed: Feb. 26, 2009

(30) Foreign Application Priority Data
Feb. 26, 2008 (JP) JP2008-044005

(51) Int. Cl. H04B 1/18

(52) U.S. Cl. 455/150.1

(57) ABSTRACT

A JFET 4 to be an antenna buffer for an AM broadcasting signal is constituted in a source follower form of a 100% negative feedback type, and a tuning circuit including a variable capacitive circuit 7 and a transformer 6 is provided in a subsequent stage to the JFET 4 and an amplifying circuit including MOSFETs 10 and 11 is provided in a further subsequent stage thereto. Consequently, it is possible to reduce a signal distortion rate in the JFET 4 and to eliminate a drawback that every frequency component enters the amplifying circuit to saturate the amplifying circuit, resulting in an occurrence of a distortion in an output signal. By switching a plurality of capacitors CT1, CT2, . . . CTn to cause a capacitance value to be variable without using a varactor diode, it is possible to integrate the capacitors CT1, CT2, . . . CTn in an IC 20.

### BACKGROUND OF THE INVENTION

1. Field of the Invention

The present invention relates to an AM broadcast receiving circuit, and more particularly to a circuit to be used in antenna matching in an on-vehicle radio receiver, for example.

2. Description of the Related Art

In general, a bar antenna is used for receiving an AM broadcast. There has been employed a mechanism in which an inductance of the bar antenna and a variable capacitive capacitor are combined to constitute a tuning circuit and tuning with an AM broadcasting frequency is taken by using the tuning circuit. In case of an on-vehicle radio receiver provided in a car covered with a metal body, however, an electric wave reaching an inside of the car is greatly attenuated because of a shielding effect produced by the metal body. For this reason, it is impossible to use the bar antenna.

Therefore, it is necessary to raise a whip antenna on an outside of the car or to use a glass antenna constituted by sticking a transparent metal to a glass surface of a window. The on-vehicle antenna and the radio receiver in the car are connected to each other through a coaxial cable or the like. More specifically, the coaxial cable or the like is used as a feeder wire for transmitting, to the radio receiver, an electric wave signal captured through the on-vehicle antenna.

On the other hand, in many cases, a receiving circuit of an untuning system is used in an antenna matching circuit of an on-vehicle radio receiver (for example, see FIG. 3(b) of Patent Document 1). FIG. 5 is a diagram showing an example of a conventional structure of an AM broadcast receiving circuit of an untuning system to be used for an on-vehicle AM radio receiver. As shown in FIG. 5, the conventional AM broadcast receiving circuit of the untuning system is constituted by a coupling capacitor 101, resistors 102 and 103, a signal amplifying FET 104, a coupling capacitor 105, and an amplifying circuit 106.

Patent Document 1: Japanese Laid-Open Patent Publication No. 2002-204129

The coupling capacitor 101 serves to cut a DC component of an AM broadcasting signal to be input through the on-vehicle antenna which is not shown. The resistor 102 serves to apply a proper bias to the signal amplifying FET 104. The signal amplifying FET 104 is an initial stage amplifying circuit for amplifying an input AM broadcasting signal and is constituted by a junction FET (a junction field effect transistor=JFET), for example. Since the JFET makes a very small flicker noise (1/f noise) or thermal noise, it is often used.

In the AM broadcast receiving circuit having such a structure, an AM broadcasting signal passing through the coupling capacitor 101 is amplified by the initial stage amplifying circuit constituted by the JFET 104, and the AM broadcasting signal thus amplified is output from a drain terminal and is supplied to the subsequent stage amplifying circuit 106 through the coupling capacitor 105. The subsequent stage amplifying circuit 106 is integrated on an IC by using a bipolar transistor and is therefore constituted in such a manner that an input impedance is reduced.

In the AM broadcast receiving circuit shown in FIG. 5, however, the JFET 104 of the initial stage amplifying circuit is used for source grounding. In case of the source grounding, there is a problem in that an input signal of the JFET 104 is amplified, resulting in an occurrence of a distortion in an output signal.

In case of the AM broadcast receiving circuit shown in FIG. 5, untuning is taken and the input impedance of the subsequent stage amplifying circuit 106 is also low. Therefore, every frequency component enters the subsequent stage amplifying circuit 106. For this reason, there is also a problem in that the subsequent stage amplifying circuit 106 is operationally saturated, resulting in an occurrence of a distortion in a signal to be amplified and output.

In order to avoid the problem, for example, there is also an AM broadcast receiving circuit which is provided with a bipolar transistor 107 for an AGC (Automatic Gain Control) in an output stage (a drain side) of the JFET 104 and regulates an amplitude of the output signal of the JFET 104 corresponding to a detection level of a received signal (an RF signal which has not been subjected to a frequency conversion or an IF signal subjected to the frequency conversion) as shown in FIG. 6.

As another method of avoiding a problem that every frequency component enters the subsequent stage amplifying circuit 106, resulting in an occurrence of a distortion, a receiving circuit of a tuning system is used in some cases (for example, see FIG. 3(a) in Patent Document 1). FIG. 7 is a diagram showing an example of a conventional structure of an AM broadcast receiving circuit of a tuning system which is used in an on-vehicle AM radio receiver. As shown in FIG. 7, the conventional AM broadcast receiving circuit of the tuning system is constituted by a coupling capacitor 101, a resistor 102, a signal amplifying FET 104 to be an initial stage amplifying circuit, a coupling capacitor 105, a subsequent stage amplifying circuit 106, and a tuning circuit 108.

The tuning circuit 108 radio-frequency amplifies an RF signal output from the signal amplifying FET 104 and outputs the amplified signal to the subsequent stage amplifying circuit 106, and is constituted by a capacitor C1 and a varactor diode D1 for tuning and coils L1 and L2 for tuning. In the AM broadcast receiving circuit shown in FIG. 7, a capacitance value of the varactor diode D1 is variably set to take tuning with an AM broadcasting frequency of a desirable station and only the tuned frequency component is supplied to the subsequent stage amplifying circuit 106. Consequently, it is possible to prevent an occurrence of a distortion in an output signal which is caused by saturation in the subsequent stage amplifying circuit 106

In the AM broadcast receiving circuit of the tuning system shown in FIG. 7, however, the varactor diode D1 is used for taking tuning with the AM broadcasting frequency of the desirable station. If the varactor diode D1 is to be integrated into an IC of a CMOS (Complementary Metal Oxide Semiconductor), a change characteristic of a capacitance value with respect to an input voltage shows a very steep curve as shown in FIG. 8. Consequently, there is a problem in that a distortion is apt to occur in an output signal when a signal having a high level is input. For this reason, it is necessary to constitute the tuning circuit 108 including the varactor diode D1 as an external component of the IC. Thus, the number of the external components is increased.

### DISCLOSURE OF THE INVENTION

As described above, in the AM broadcast receiving circuit of the untuning system shown in FIG. 5, the JFET 104 of the initial stage amplifying circuit is used for the source grounding. For this reason, there is a problem in that an input signal is amplified by the JFET 104, resulting in an occurrence of a distortion in the output signal. Moreover, the AM broadcast receiving circuit of the untuning system shown in FIG. 5 takes untuning and has a low input impedance of the subsequent stage amplifying circuit 106. Therefore, there is also a problem in that every frequency component enters the subsequent stage amplifying circuit 106 and the subsequent stage amplifying circuit 106 is saturated, resulting in an occurrence of a distortion in the output signal.

In case of the AM broadcast receiving circuit shown in FIG. 5, every frequency component enters the subsequent stage amplifying circuit 106. For this reason, there is also a problem in that a beat interference such as a cross modulation is apt to be caused. Particularly, since the whip antenna is much shorter than a wavelength of an AM electric wave, it is capacitive. Since the whip antenna has a rod antenna-shaped structure, it can be expanded and contracted freely and a capacitance value is changed depending on a length. Furthermore, a length of the coaxial cable to be used as a feeder wire is varied depending on a type of a car, which also causes a variation in a capacity. In the AM broadcast receiving circuit of the untuning system shown in FIG. 5, therefore, tuning with an AM broadcast receiving frequency is taken with difficulty so that a beat interference is apt to be caused by a cross signal.

In the case in which a transistor 107 for an AGC is provided as shown in FIG. 6, it is possible to regulate the level of the signal to be input to the subsequent stage amplifying circuit 106. Consequently, it is possible to eliminate a drawback that the subsequent stage amplifying circuit 106 is saturated, resulting in an occurrence of a distortion in an output signal. Also in the AM broadcast receiving circuit shown in FIG. 6, however, it is impossible to eliminate a drawback that the distortion occurs in the output signal when a received signal having a high level exceeding a threshold voltage Vth of the JFET 104 is input. Moreover, there is also a problem in that the level of the signal input to the subsequent stage amplifying circuit 106 is reduced due to an AGC operation and a level of a frequency of a desirable station is also reduced simultaneously, resulting in a deterioration in a receiving sensitivity.

In the AM broadcast receiving circuit of the tuning system shown in FIG. 7, there is a problem in that the distortion occurs in the output signal when the received signal having the high level exceeding the threshold voltage Vth of the JFET 104 is input. In addition, there is a problem in that the distortion is apt to occur in the output signal when a signal having a high level is input if the varactor diode D1 is integrated into an IC. On the other hand, there is a problem in that the number of external components is increased and a circuit scale is thus enlarged when the tuning circuit 108 including the varactor diode D1 is constituted on an outside of the IC.

In order to solve the problems, it is an object of the present invention to constitute, in a small circuit scale, an AM broadcast receiving circuit causing a distortion of an output signal or a beat interference with difficulty even if a received signal having a high level is input by decreasing the number of external components of an IC as greatly as possible.

In order to attain the object, the AM broadcast receiving circuit according to the present invention has a structure in which a junction FET to be an antenna buffer for inputting a received AM broadcasting signal is constituted in a source follower form, a subsequent stage to the antenna buffer is provided with a tuning circuit for switching a capacitor to be used, thereby causing a capacitance value to be variable, and furthermore, an amplifying circuit formed by an MOSFET is provided in a subsequent stage thereto.

According to the present invention having the structure described above, the junction FET of the antenna buffer is constituted in the source follower form. In the junction FET, therefore, the input signal is not amplified. Consequently, it is possible to prevent the distortion of the output signal from occurring due to an amplification. Moreover, a full feedback is applied to a gate of the junction FET. Consequently, it is possible to prevent the distortion from occurring in the output signal even if a signal having a high level exceeding a threshold voltage of the junction FET is input. Furthermore, the tuning circuit is provided in an input stage of the amplifying circuit. Therefore, only a tuned frequency component is supplied to the amplifying circuit. Consequently, the distortion caused by saturation in the amplifying circuit can be prevented from occurring in the output signal, and furthermore, a cross modulation can be prevented from occurring due to various frequency components so that a beat interference can be suppressed. In addition, the tuning circuit is constituted without using the varactor diode. Therefore, it is possible to prevent a distortion from occurring due to a nonlinearity of the varactor diode. Moreover, a plurality of capacitors constituting the tuning circuit can be integrated in an IC and a distortion can be prevented from occurring in an output signal even if a signal having a high level is input. Thus, it is possible to constitute, in a small circuit scale, an AM broadcast receiving circuit causing a distortion of an output signal or a beat interference with difficulty even if an AM broadcasting signal having a high level is input by decreasing the number of external components of an IC as greatly as possible.

### BRIEF DESCRIPTION OF THE DRAWINGS

FIG. 1 is a diagram showing an example of a structure of an AM broadcast receiving circuit according to the present embodiment,

FIG. 2 is a diagram showing another example of a structure of a variable capacitive circuit according to the present embodiment,

FIG. 3 is a diagram showing another example of the structure of the AM broadcast receiving circuit according to the present embodiment,

FIG. 4 is a diagram showing another example of the structure of the variable capacitive circuit according to the present embodiment,

FIG. 5 is a diagram showing an example of a conventional structure of an AM broadcast receiving circuit of an untuning system which is to be used in an on-vehicle AM radio receiver,

FIG. 6 is a diagram showing an example of the conventional structure of the AM broadcast receiving circuit of the untuning system which is to be used in the on-vehicle AM radio receiver,

FIG. 7 is a diagram showing an example of a conventional structure of an AM broadcast receiving circuit of a tuning system which is to be used in the on-vehicle AM radio receiver, and

FIG. 8 is a chart showing a capacitance value change characteristic in the case in which a varactor diode is integrated in an IC.

### DETAILED DESCRIPTION OF THE PREFERRED EMBODIMENTS

An embodiment according to the present invention will be described below with reference to the drawings. FIG. 1 is a diagram showing an example of a structure of an AM broadcast receiving circuit according to the present embodiment. As shown in FIG. 1, the AM broadcast receiving circuit according to the present embodiment includes a coupling capacitor 1, resistors 2 and 3, a junction FET (JFET) 4, a coupling capacitor 5, a transformer 6, a variable capacitive circuit 7, resistors 8 and 9, and MOSFETs 10 and 11.

The coupling capacitor 1 serves to cut a DC component of an AM broadcasting signal input through an on-vehicle antenna which is not shown. The resistors 2 and 3 serve to apply a proper bias to the JFET 4. The JFET 4 is an antenna buffer for inputting the received AM broadcasting signal without an amplifying operation and is constituted in a source follower form. More specifically, a drain terminal of the JFET 4 is connected to a power supply Vcc and an input signal is output from a source terminal.

More specifically, an AM broadcasting signal passing through the coupling capacitor 1 is input to the antenna buffer constituted by the JFET 4. Then, the AM broadcasting signal input to the JFET 4 is output from the source terminal of the JFET 4 and is supplied to the transformer 6 in a subsequent stage through the coupling capacitor 5.

The transformer 6 has a primary winding (a primary coil) L1 and a secondary winding (a secondary coil) L2, and constitutes a tuning circuit together with the variable capacitive circuit 7. The variable capacitive circuit 7 is constituted by a plurality of capacitors CT1, CT2, . . . CTn having fixed capacitance values and a switch S1 for switching to one capacitor to be used from among the capacitors CT1, CT2, . . . CTn. The capacitance values of the capacitors CT1, CT2, . . . CTn are different from each other.

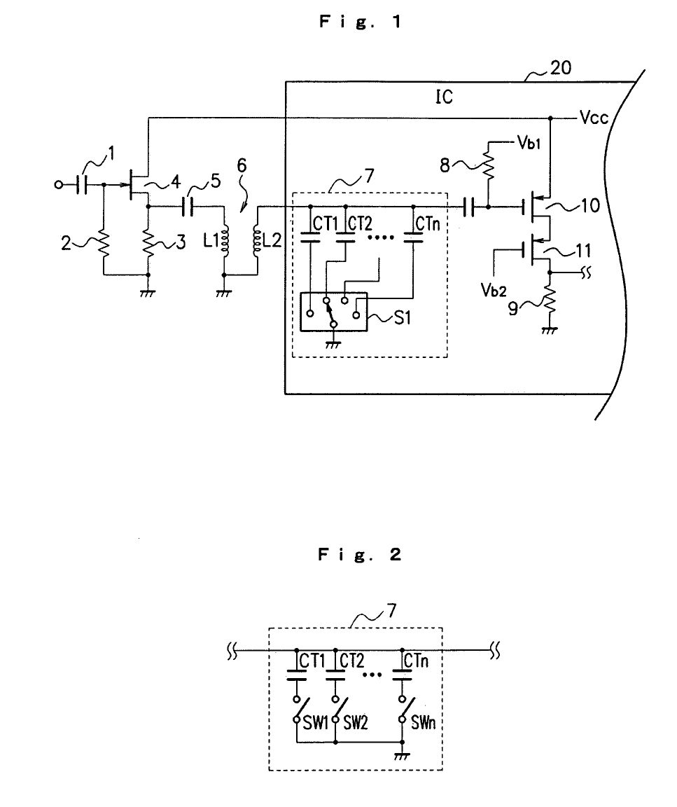

The variable capacitive circuit 7 may be constituted as shown in FIG. 2. In the structure shown in FIG. 2, the variable capacitive circuit 7 includes a plurality of capacitors CT1, CT2, . . . CTn having fixed capacitance values and a plurality of switches SW1, SW2, . . . SWn connected to the capacitors CT1, CT2, . . . CTn, respectively. The switches SW1 to SWn are provided in series to the capacitors CT1 to CTn, and the series circuits are connected in parallel with each other. The switches SW1 to SWn carry out a switching operation synchronously with a channel selecting frequency synthesizer which is not shown.

In case of the structure shown in FIG. 2, it is possible to cause capacitance values of capacitors connected in parallel with the coil L2 to be variable by turning on at least one of the switches SW1 to SWn. Consequently, a tuning frequency can be switched. In the case in which the switches are turned ON, it is possible to obtain a great capacitance value by adding the capacitance values of the capacitors connected to the switches which are turned ON. Therefore, the capacitance values of the capacitors CT1 to CTn may be smaller than those in FIG. 1. In FIG. 2, the capacitance values of the capacitors CT1 to CTn may be different from each other or may be equal to each other.

The tuning circuit constituted by the transformer 6 and the variable capacitive circuit 7 inputs a signal output from the JFET 4 to the primary coil L1 of the transformer 6 through the coupling capacitor 5 and varies the capacitance value of the variable capacitive circuit 7, thereby taking tuning with an AM broadcasting frequency of a desirable station with respect to the signal output through the secondary coil L2. Moreover, the tuning circuit radio-frequency amplifies the signal output from the JFET 4 and outputs the amplified signal to an amplifying circuit in a subsequent stage depending on a turn ratio of the primary and secondary coils L1 and L2 of the transformer 6.

The amplifying circuit is connected to the subsequent stage to the tuning circuit and is constituted by the two MOSFETs 10 and 11 which are cascode connected. The resistors 8 and 9 apply a proper bias to the two MOSFETs 10 and 11. In other words, a proper bias is applied to the MOSFET 10 acting as a first stage of the cascode connection through the resistor 8 and a proper bias is applied to the MOSFET 11 acting as a second stage of the cascode connection through the resistor 9. A signal is output from a drain terminal of the MOSFET 11 in a second stage to a mixer circuit (not shown) in a subsequent stage.

With the structure described above, the variable capacitive circuit 7 constituting the tuning circuit, the MOSFETs 10 and 11 constituting the amplifying circuit, and the resistors 8 and 9 for applying a bias to the MOSFETs 10 and 11 are integrated in an integrated circuit (IC) 20 employing a CMOS process. By using the variable capacitive circuit 7 in place of the varactor diode, it is possible to enhance a linearity of a change characteristic of the capacitance value with respect to an input voltage. By setting the switch S1 of the variable capacitive circuit 7 to be a CMOS switch in place of pMOS and nMOS switches, it is possible to cause the linearity of the change characteristic of the capacitance value to be more excellent. On the other hand, the coupling capacitor 1, the resistors 2 and 3, the JFET 4, the coupling capacitor 5 and the transformer 6 are constituted as external components of the IC 20.

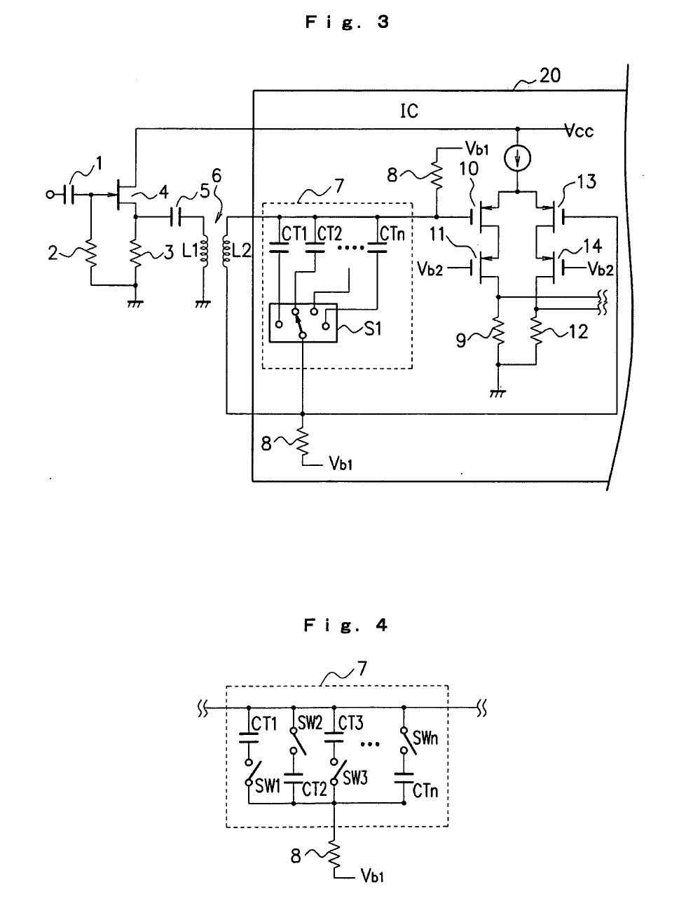

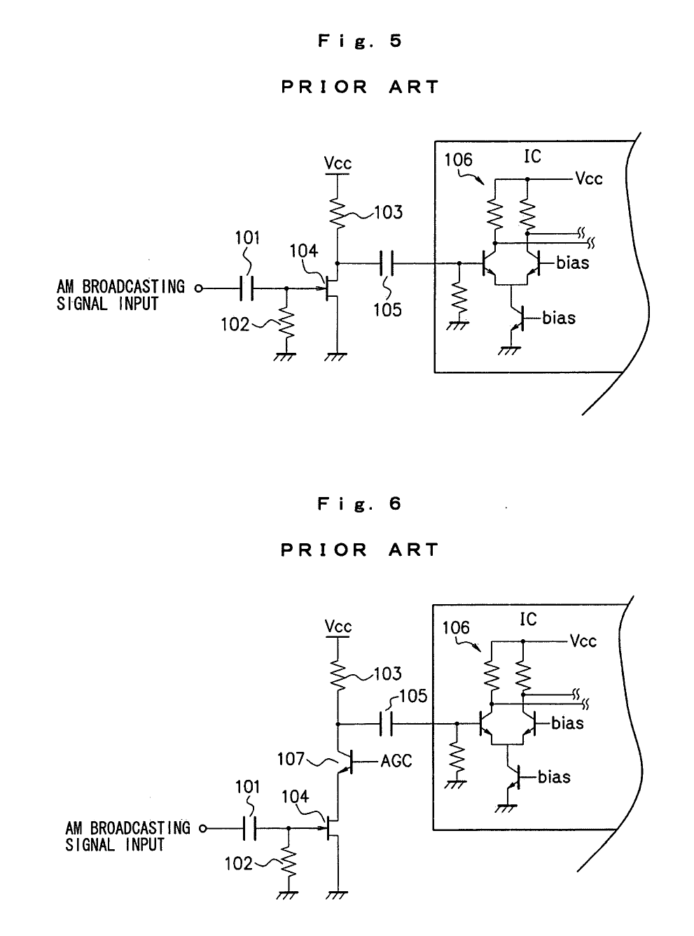

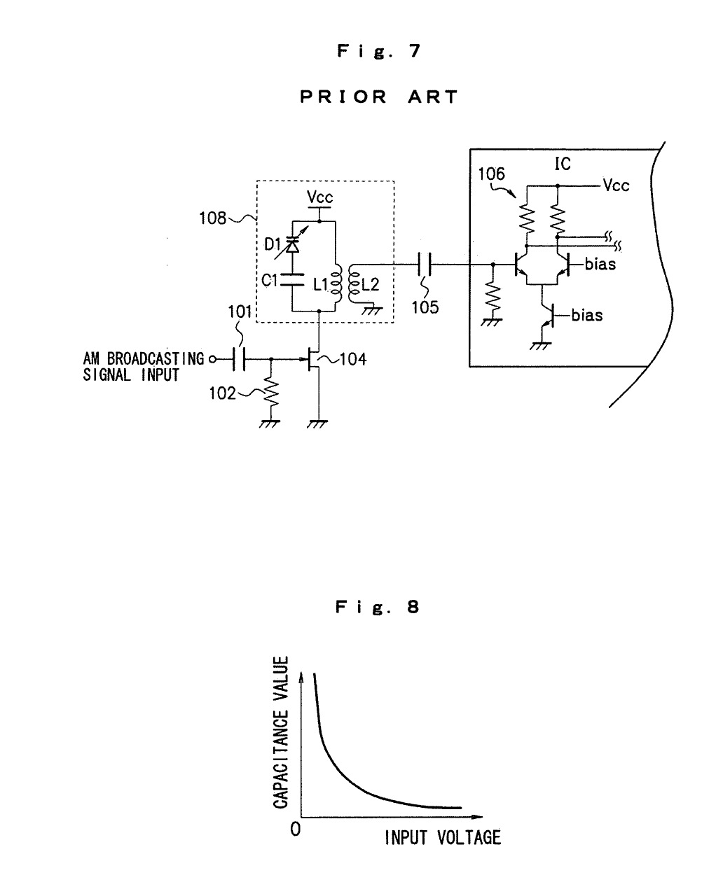

Although FIG. 1 shows the example in which the cascode amplifier constituted by the two MOSFETs 10 and 11 is used as an amplifying circuit, a differential amplifier constituted by using four MOSFETs 10 to 14 may be used as an amplifying circuit as shown in FIG. 3.

With a structure shown in FIG. 3, the coil L2 and the variable capacitive circuit 7 are connected between two differential inputs of the differential amplifier (between gates of the MOSFETs 10 and 13). Moreover, the same bias Vb1 is also applied through the resistor 8 to the MOSFET 13 as well as the MOSFET 10 to be one of the differential inputs. Moreover, the bias Vb1 is applied to one of ends of the switch S1. By such a structure, it is possible to enhance a differential balance, thereby improving the linearity of the differential amplifier.

In the case in which the amplifying circuit is constituted by the differential amplifier as shown in FIG. 3, the variable capacitive circuit 7 may be constituted as shown in FIG. 4. In FIG. 4, components having the same functions as those shown in FIG. 2 have the same reference numerals. In FIG. 4, series connecting orders of a plurality of capacitors CT1 to CTn and a plurality of switches SW1 to SWn are alternately changed.

More specifically, in a first series circuit, the capacitor CT1 is connected to a gate side of the MOSFET 10 and the switch SW1 is connected to the bias resistor 8 side. In a second series circuit which is adjacently connected in parallel, the capacitor CT2 is connected to the bias resistor 8 side and the switch SW2 is connected to the gate side of the MOSFET 10. In a third series circuit which is adjacently connected in parallel, furthermore, the capacitor CT3 is connected to the gate side of the MOSFET 10 and the switch SW3 is connected to the bias resistor 8 side. Similarly, series connecting orders of the capacitors CT4 to CTn and the switches SW4 to SWn are also changed alternately.

By such a structure, it is possible to prevent a stray capacitance from being applied to only one of the two MOSFETs 10 and 13 constituting the differential inputs. Thus, it is possible to further enhance the differential balance. Consequently, the linearity of the differential amplifier can further be improved.

As described above in detail, in the present embodiment, there is employed the structure in which the JFET 4 to be an antenna buffer for inputting the received AM broadcasting signal is constituted in the source follower form, the subsequent stage to the JFET 4 is provided with the tuning circuit constituted by the variable capacitive circuit 7 for switching the capacitors CT1, CT2, CTn to be used, thereby causing the capacitance value to be variable and the transformer 6 and the amplifying circuit including the MOSFETs 10 and 11 (or the MOSFETs 10 to 14) is provided in a further subsequent stage.

The amplifying operation is not carried out in the source follower form. Therefore, it is possible to eliminate the distortion of the output signal due to the amplification of the input signal through the JFET 4. Moreover, the source follower form provides a 100% negative feedback circuit (a full feedback) Also in the case in which a distortion rate of the circuit itself is low and an AM broadcasting signal having a high level exceeding the threshold voltage of the JFET 4 is input, therefore, a cross modulation is caused with difficulty. Since the JFET 4 constituting the source follower circuit makes a very small flicker noise (1/f noise) or thermal noise, a noise factor is excellent and the noise generated in the JFET 4 is smaller than a noise generated in an antenna. Even if an AM broadcasting signal having a high level is input, therefore, it is possible to prevent a great distortion from occurring in a signal output from the JFET 4.

According to the present embodiment, the tuning circuit is provided in the input stage of the amplifying circuit. Therefore, only a tuned frequency component is supplied to the amplifying circuit. Since the amplifying circuit is constituted by the MOSFETs 10 and 11 in place of a bipolar transistor, the input impedance is increased. When the amplifying circuit is constituted by the MOSFETs 10 and 11 to increase the input impedance, Q of the tuning circuit provided in a previous stage can also be increased. Consequently, it is possible to eliminate a drawback that every frequency component enters the amplifying circuit to saturate the amplifying circuit, resulting in an occurrence of a distortion in an output signal. In addition, the occurrence of a cross modulation due to various frequency components can also be avoided to suppress a beat interference.

The source follower circuit has a gain of one or less. When the JFET 4 is set into the source follower form, therefore, a great gain cannot be obtained in the JFET 4. On the other hand, in the present embodiment, the coil forming the tuning circuit in the subsequent stage to the JFET 4 is constituted by the transformer 6 and a voltage amplification rate based on the turn ratio of the primary coil L1 and the secondary coil L2 is utilized to radio-frequency amplify a signal output from the JFET 4 and to output the amplified signal to the MOSFETs 10 and 11 of the amplifying circuit. Even in the case in which the JFET 4 is constituted in the source follower form having a small gain, consequently, a great gain can be obtained with respect to the signal input to the amplifying circuit.

According to the present embodiment, furthermore, the tuning circuit is constituted without using the varactor diode. As described above, when the varactor diode is integrated in the IC 20, the change characteristic of the capacitance value with respect to the input voltage shows a very steep curve. When a strong signal is input, therefore, a distortion is apt to occur in an output signal. On the other hand, in the present embodiment, the tuning circuit is constituted in such a manner that the capacitors CT1, CT2, . . . CTn are switched to cause the capacitance value to be variable. Therefore, it is possible to integrate the capacitors CT1, CT2, . . . CTn in the IC 20 and to prevent the distortion from occurring in the output signal even if a signal having a high level is input. Consequently, it is possible to decrease the number of external components of the IC 20 which are used, for example, the varactor diode.

As described above, according to the present embodiment, it is also possible to constitute, in a small circuit scale, an AM broadcast receiving circuit causing a distortion of an output signal or a beat interference with difficulty even if a large AM broadcasting signal is input by decreasing the number of the external components of the IC 20 as greatly as possible.

The embodiment is only illustrative for a concreteness to carry out the present invention and the technical range of the present invention should not be construed to be restrictive. In other words, the present invention can be carried out in various forms without departing from the spirit or main features thereof.

### INDUSTRIAL APPLICABILITY

The present invention is useful for an AM broadcast receiving circuit to be utilized for antenna matching in an on-vehicle radio receiver. Although the on-vehicle radio receiver is a suitable application example, the present invention can also be used in radio receivers other than the on-vehicle radio receiver.

This application is based on Japanese Patent Application No. 2008-044005 filed on Feb. 26, 2008, the contents of which are incorporated hereinto by reference.

What is claimed is:

1. An AM broadcast receiving circuit comprising:
a junction FET in a source follower form which is an antenna buffer for inputting a received AM broadcasting signal;
a tuning circuit serving to input a signal output from the antenna buffer and to take tuning with an AM broadcasting frequency of a desirable station and including a coil, a plurality of capacitors having fixed capacitance values, and a single or plurality of switches for switching to one or a plurality of capacitors to be used; and
an MOSFET to be an amplifying circuit connected to a subsequent stage to the tuning circuit.

2. The AM broadcast receiving circuit according to claim 1, wherein the coil is constituted by a transformer having a primary winding and a secondary winding, and the tuning circuit having the transformer radio-frequency amplifies a signal output from the antenna buffer and outputs the amplified signal to the amplifying circuit corresponding to a turn ratio of the primary winding and the secondary winding.

3. The AM broadcast receiving circuit according to claim 1, wherein the plurality of capacitors and the single or plurality of switches which constitute the tuning circuit and the amplifying circuit are integrated in an integrated circuit.

4. The AM broadcast receiving circuit according to claim 3, wherein the switch is constituted by a CMOS transistor.
